(19) United States
(12) Patent Application Publication
(10) Pub. No.: US 2006/0074587 A1
(43) Pub. Date: Apr. 6, 2006

(54) Measuring method of circular shape, measuring method of cylindrical shape, and measuring apparatus of cylindrical shape

(75) Inventors: Yasuhiro Kawai, Susono-shi (JP); Kyoichi Teramoto, Numazu-shi (JP); Yoichi Kawamorita, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/281,603

(22) Filed: Nov. 18, 2005

Related U.S. Application Data
(63) Continuation of application No. PCT/JP05/16470, filed on Sep. 1, 2005.

(30) Foreign Application Priority Data
Sep. 1, 2004 (JP) 2004-254363

(51) Int. Cl. G06F 15/00

(52) U.S. Cl. 702/155

(57) ABSTRACT

The present invention aims at providing a measuring method of making loads of measurement few, making each measured value extremely exact, and efficiently reducing the number of measurement points, in cylindrical dimension measurement, and in particular, the measurement of a circumferential shape. In a measuring method of a shape of a cross-sectional circle which is orthogonal to an axis of a cylinder, the present invention is characterized by having a step of calculating distances between a reference point and points on a circumference on the basis of change of the distances of at least three predetermined points on the circumference of the cross-sectional circle to the reference point set in the cross-sectional circle by the rotation of the cylinder, and specifying the shape of the cross-sectional circle.

This application is a continuation of International Application No. PCT/JP2005/016470, filed Sep. 1, 2005, which claims the benefit of Japanese Patent Application No. 2004-254363 filed on Sep. 1, 2004.

### BACKGROUND OF THE INVENTION

1. Field of the Invention

The present invention relates to a measuring method of a shape of a cross-sectional circle in a direction orthogonal to an axis of a cylinder, and a shape of a cylinder, and a measuring apparatus used for this. In particular, the present invention relates to the technology of contributing to precision measurement at the time of cutting an outer surface of a cylindrical member, as means of obtaining an accurate cylindrical member. The scopes of the measuring technique acquired by the present invention are various. In particular, the present inventor and et al. applied the present invention to an image forming member of an electrophotographic system of copier, laser beam printer, facsimile, or printer, or the measurement of its base substrate, and verified its effects.

2. Related Background Art

Heretofore, a cylindrical member whose shape is finished with predetermined accuracy has been used for an electrophotographic photosensitive drum or a development sleeve in an image forming apparatus such as an electrophotographic system of copier, laser beam printer, facsimile, or printing machine. An electrophotographic photosensitive drum is produced by giving a photosensitive film to a surface of a drum substrate which is finished with predetermined accuracy. Nevertheless, there is a problem that convexo-concave arises in a photosensitive film when the accuracy of dimensions of the drum substrate is low, and for this reason, a defect arises in an image of an image forming apparatus. Hence, in order to obtain high-precision image forming apparatus, high accuracy is required in a cylindricity, a roundness, and the like of the drum substrate.

Furthermore, also in the process of producing such a drum substrate, a highly precise measurement function aiming at assuring the accuracy of dimensions is required, and the following conventional technology is known as methods aiming at it. A method of measuring a surface shape by a zonal laser or other measuring means while standing and rotating a measured cylinder (a cylinder which is a measuring object, and this is the same hereafter) on a rotatable base (for example, refer to Japanese Patent Application Laid-Open No. H06-201375 (patent document 1)). A method of holding both ends of a measured cylinder with a certain holder and rotating the cylinder, and measuring the size of interrupting a zonal laser to measure cylindrical shape (for example, refer to Japanese Patent Application Laid-Open No. H08-005341 (patent document 2)). A method of performing measurement by the approximate calculation of the measured values acquired from displacement detectors facing an outer peripheral section of a measured cylinder by rotating the measured cylinder without fixing a rotation axis (for example, refer to Japanese Patent Application Laid-Open No. H06-147879 (patent document 3)) and the like. Nevertheless, in addition to such a request to extended definition of an image forming apparatus, a simpler measuring system aiming at the reduction of manufacturing cost becomes indispensable in recent years. Furthermore, with mentioning a cylindrical measuring method with following needs as industrial product evaluation, items to be evaluated should be classified into the accuracy of dimensions as a cylinder, and partial geometrical defects of a surface, and measuring means suitable for each object should be used. Here, according to the measurement of accuracy of dimensions, in a field of measuring the accuracy of dimensions of a circumferential shape of a cylinder, especially a circumferential shape of a cylinder which premises that it has such a high level of accuracy that the present invention may make it an object, it is possible to make it sufficient evaluation even if the number of measured points is a small number comparatively when each measured value is very exact. Hence, industrially, it is preferable to reduce the number of measurement points as much as possible, and to aim at reducing processing time. On the other hand, even if the number of measurement points is increased at the time of evaluating a partial geometrical defect of a cylindrical surface, it is difficult to evaluate all microdefects such as a hairline-like scratch defect. Hence, it is not preferable also in this point to make the number of measurement points increase. Hence, evaluation means by surface defect analysis such as image processing which replaces it should be used. That is, when performing the dimensional accuracy measurement of a circumferential shape of a cylinder as industrial product evaluation, from a viewpoint of pursuing measurement efficiency, it can be said that it is most preferable that there are few loads concerning measurement, each measured value is exact, and the number of measurement points is suppressed to the minimum. In this point, although the conventional method of measuring a surface shape by measuring means such as a zonal laser while standing a measured cylinder on a rotatable base and rotating this (for example, refer to Japanese Patent Application Laid-Open No. H06-201375 (patent document 1)) can acquire very highly precise measured value, it is not easy to reduce measuring time and loads since preparatory work such as precise centering of the measured cylinder on the base in measurement is required. In addition, the method of holding both ends of a measured cylinder with a certain holder and rotating the cylinder, and measuring the size of interrupting a zonal laser to measure cylindrical shape (for example, refer to Japanese Patent Application Laid-Open No. H08-005341 (patent document 2)) can perform comparatively simple measurement. On the other hand, the variation of a cylindrical wall thickness affects a measured value, the fitting gap size of the holder of both ends, deformation of ends by a holding force, the vibration of a shaft arising at the time of rotating the measured cylinder, or the like becomes easily a cause of generating a measurement error. Furthermore, the method of performing measurement by the approximate calculation of the measured values acquired from displacement detectors facing an outer peripheral section of a measured cylinder by rotating the measured cylinder without fixing a rotation axis (for example, refer to Japanese Patent Application Laid-Open No. H06-147879 (patent document 3)) is simple and can suppress an influence of accuracy of an instrument concerning measurement over measurement result. On the other hand, this has a feature that, since the measurement result is approximately calculated values, it increases the accuracy of each. *measured value to make the number of measurement points and an order of an approximate calculation increase. It is required that the number of measurement points is at least 64 points or 100 points or more. Hence, it is hardly possible by this method to reduce the number of measurement points, and this method takes comparatively long measuring time.

Thus, the conventional technology has not provided a dimensional accuracy measuring method of a circumferential shape of a cylinder as industrial product evaluation which makes loads, concerning measurement, minimum from a viewpoint of measurement efficiency, and makes it possible for each measured value to be exact and to suppress the number of measurement points to the minimum.

### SUMMARY OF THE INVENTION

In view of such problems, the present invention was conducted to aim at making loads of measurement few, making each measured value exact, and efficiently reducing the number of measurement points, in cylindrical dimension measurement, and in particular, the measurement of a circumferential shape.

That is, what is provided according to one aspect of the present invention is a measuring method of a shape of a cross-sectional circle which is orthogonal to an axis of a cylinder, the shape measuring method of a cross-sectional circle orthogonal to an axis of a cylinder which is characterized by having a step of calculating distances between a reference point and points on a circumference on the basis of the change of the distances between the reference point set in the cross-sectional circle and at least three predetermined points on the circumference of the cross-sectional circle by rotation of the cylinder, and specifying the shape of the cross-sectional circle.

Most of conventional measuring methods require loads so as to pursue the accuracy of mechanical limitation of a cylinder center as a measurement reference position for the purpose of acquiring the higher accuracy of measurement. On the other hand, a method which the present invention provides premises that this cylinder center is such a virtual center that moves by rotation, i.e., a floating center. Therefore, the measuring method of the present invention is characterized by tracking, theoretically catching, and limiting a position of this floating center on the basis of the change of numerical values acquired from a gauge headline by one according to the measurement without giving mechanical limitation. Hence, since there is no need of limiting the above mentioned cylinder center exactly according to the measuring method of the present invention, it is possible to measure a circumferential shape of a cylinder with high accuracy simply without accompanying such all loads.

In addition, in the method which the present invention provides, since each measured value can obtain measurement result which is directly measured without being approximately calculated, each measured value is not influenced by the number of measurement points. Because of this, the number of measurement points at the time of measuring a circumferential shape (dimensional accuracy) of the above-mentioned cylinder which is premised on having high accuracy originally like an object of the present invention is ten points or about 20 points, that is, it is possible to perform measurement required for accuracy assurance of a product at the necessary minimum number of measurement points. Hence, in performing the accuracy measurement of a cylinder as industrial product evaluation, it can be said that the present invention is very ideal from a viewpoint of pursuing measurement efficiency.

In addition, according to another aspect of the present invention, what is provided as a method of measuring a cylindrical shape of a cylinder using this method is a measuring method of a cylindrical shape of a cylinder characterized by having: a step of moving a plurality of detectors, which measure the cylinder size of the cylinder from a direction orthogonal to a cylinder central axis of the cylinder, in parallel to the cylinder central axis; and a step of calculating a plurality of detection signals in predetermined positions obtained from a plurality of above-mentioned detectors, in making the cylinder a measured object, and making the cylinder rotate in its circumferential direction to measure a cylindrical shape of thee cylinder, and in that the cylindricity of the measured cylinder is measured by obtaining a circumferential shape and a roundness of a cross-sectional circle orthogonal to the above-mentioned cylinder central axis using the above-mentioned measuring method of a circumferential shape in rotating and measuring a-measured cylinder in the method of measuring the cylindricity and roundness of the cylinder.

In addition, according to further aspect of the present invention, what is provided is a method of measuring a cylindrical shape according to a flowchart shown in FIG. 1 using measuring means of having a cylinder support jig on which the measured cylinder is placed and which rotates this., and three or more displacement detectors which are located on the same cross-section, which is orthogonal to a rotation axis of the measured cylinder, on a mount provided rotatably in parallel to the rotation axis of the measured cylinder, which are oriented to the measurement reference point (O₀) which is an intersection of the rotation axis of the measured cylinder, and the cross-section orthogonal to the rotation-axis, and which are arranged in a fan shape every predetermined angle (θ°) with O₀ as a center and are fixed to the mount.

Specifically, a measuring method of a cylindrical shape which obtains a cylindricity of a measured cylinder by the following steps (i) to (vi) using measuring means having a cylinder support jig on which the measured cylinder is placed and which rotates this, and three or more displacement detectors which are located on the same cross-section, which is orthogonal to a rotation axis of the measured cylinder, on a mount provided rotatably in parallel to the rotation axis of the measured cylinder, which are oriented to the measurement reference point (O₀) which is an intersection of the rotation axis of the measured cylinder, and the cross-section orthogonal to the rotation axis, and which are arranged in a fan shape every predetermined angle (θ°) with O₀ as a center and are fixed to the mount:
(i) a step of measuring a distance from a measurement reference point to points on a circumference of the cross-sectional circle orthogonal to the axis of the measured cylinder by displacement detectors,
(ii) a step of repeating the above-mentioned step (i) in a state of rotating the measured cylinder by θ°,
(iii) a step of calculating respective distance from the measurement reference point to n points (n=360/θ) on the circumference of the cross-sectional circle by repeating the above-mentioned steps (i) and (ii),
(iv) a step of calculating a circle center position and a roundness of the cross-sectional circle by a least square circle center method using these respective distance,
(v) a step of moving the mount in parallel to a rotation central axis of the measured cylinder and calculating a circle center position and a roundness of each cross-sectional circle by the above-mentioned steps (i) to (iv) about different cross-sectional circles of the measured cylinder, and
(vi) a step of making a straight line, which connects the circle centers of two cross-sectional circles in both ends of the measured cylinder among the cross-sectional circles from which the circle center positions and roundness are calculated at the above-mentioned steps (i) to (v), be a cylinder central axis, calculating distances from each intersection point of this circle central axis and the cross-sectional circles other than the two cross-sectional circles in the ends of the measured cylinder among the cross-sectional circles, from which these circle center positions and roundness are calculated, to the predetermined points on the circumference of each cross-sectional circle, and obtaining the difference between a maximum value and a minimum value of the distances.

Another aspect of the present invention provides a measuring method of a cylindrical shape of a cylinder characterized by having two displacement detectors A and B arranged with sandwiching an angle and two displacement detectors A′ and B′ arranged with sandwiching an angle θ, and in that an angle formed by A and A′, or B and B′ is positive integer times the above-mentioned θ.

In addition, still another aspect of the present invention provides a measuring method of a cylindrical shape of a cylinder characterized by arranging a displacement detector in a measured cylinder, and obtaining a wall thickness, a circle center of an inner circumferential circle, and a roundness of the measured cylinder.

Furthermore, a further aspect of the present invention provides a measuring method of cylindrical shapes of a composite cylinder, characterized by measuring at least one cylinder, which constitutes the composite cylinder, by any one of the above-mentioned methods for the composite cylinder which is constituted of a plurality of cylinders whose diameters are different, and shares a rotation central axis in outer circumferential circles of all the cylinders, measuring cylindrical shapes of cylinders other than the above-mentioned one cylinder using at least one displacement detector respectively, and obtaining all cylindrical shapes and a concentricity, and wall thicknesses of the composite cylinder.

Moreover, a still further aspect of the present invention provides a measuring apparatus of a cylindrical shape of a cylinder, characterized by comprising: measuring means having a cylinder support jig on which the measured cylinder is placed and which rotates this, and three or more displacement detectors which are located on the same cross-section, which is orthogonal to a rotation axis of the measured cylinder, on a mount provided rotatably in parallel to the rotation axis of the measured cylinder, which are oriented to the measurement reference point (O₀) which is an intersection of the rotation axis of the measured cylinder, and the cross-section orthogonal to the rotation axis, and which are arranged in a fan shape every predetermined angle (θ°) with O₀ as a center and are fixed to the mount; and calculation means of executing the following steps (i) to (vii):
(i) a step of measuring distance from a measurement reference point to points on the circumference of the cross-sectional circle orthogonal to the axis of the measured cylinder by displacement detectors,
(ii) a step of repeating the above-mentioned step (i) in a state of rotating the measured cylinder by θ°,
(iii) a step of calculating respective distances from the measurement reference point to n points (n=360/θ) on the circumference of the cross-sectional circle by repeating the above-mentioned steps (i) and
(iv) a step of calculating a circle center position and a roundness of the cross-sectional circle by a least square circle center method using these respective distances,
(v) a step of moving the mount in parallel to a rotation central axis of the measured cylinder and calculating a circle center position and a roundness of each cross-sectional circle by the above-mentioned steps (i) to (iv) about different cross-sectional circles of the measured cylinder, and
(vi) a step of making a straight line, which connects the circle centers of two cross-sectional circles in both ends of the measured cylinder among the cross-sectional circles from which the circle center positions and roundness are calculated at the above-mentioned steps (i) to (v), be a cylinder central axis; calculating distances from each intersection of this circle-central axis and the cross-sectional circles other than the two cross-sectional circles in the ends of the measured cylinder among the cross-sectional circles, from which these circle center positions and roundness are calculated, to the predetermined points on the circumference of each cross-sectional circle, and obtaining the difference between a maximum value and a minimum value of the distances.

Most of conventional measuring methods require loads so as to pursue the accuracy of mechanical limitation of a cylinder center as a measurement reference position for the purpose of acquiring the higher accuracy of measurement. On the other hand, methods which the present invention provides premise that this cylinder center is a virtual center, i.e.., a center which may move by rotation. Therefore, the measuring methods of the present invention track, and theoretically catch a position of this floating center on the basis of the change of numerical values acquired from a gauge head one by one according to the measurement without giving mechanical limitation. The measuring methods can specify a shape of a circle, which is a measuring object, by calculating distances between the floating center and points on a circumference of a circle. Hence, since there is no need of limiting the above-mentioned cylinder center exactly according to the methods of the present invention, it is possible to measure a cylinder with high accuracy simply without accompanying such all loads. In addition, in the methods which the present invention provides, a rotation method in the measurement of a measured cylinder is not limited. Hence, it is possible to perform measurement in a state of making both end sections free, or in a state of mounting parts such as a flange. Hence, even if a measuring mechanism using a measuring method of the present invention is mounted in a production line, it is possible to perform highly precise measurement very simply without problems such as an interference with conveyance means.

### BRIEF DESCRIPTION OF THE DRAWINGS

FIG. 1 is a measurement flowchart;

FIG. 2 is a schematic diagram of a measuring apparatus;

FIG. 3 is an explanatory diagram of measuring points;

FIG. 4 is an explanatory diagram relating to the movement of a floating center;

FIG. 5 is an explanatory diagram (1) relating to the calculation of a floating centre position;

FIG. 6 is an explanatory diagram (2) relating to the calculation of a floating centre position;

FIG. 7 is a diagram showing positions of displacement detectors in a first embodiment;

FIG. 8 is a diagram showing positions of displacement detectors in a second embodiment;

FIG. 9 shows data from measured values of displacement detectors to coordinate positions of circle centers in samples 1 to 5 obtained in the first embodiment;

FIG. 10 shows data from measured values of displacement detectors to coordinate positions of circle centers in samples 6 to 10 obtained in the first embodiment;

FIG. 11 shows rectangular coordinate positions of respective points on the basis of center coordinate positions, distances to respective points, and their maximum values and minimum values in samples 1 to 5 obtained in the first embodiment;

FIG. 12 shows rectangular coordinate positions of respective points on the basis of center coordinate positions, distances to respective points, and their maximum values and minimum values in samples 6 to 10 obtained in the first embodiment;

FIG. 13 shows roundness obtained in the first embodiment and a first comparative example;

FIG. 14 is a graph of comparing roundness obtained in the first embodiment and first comparative example;

FIG. 15 shows measurement durations and difference which were obtained in the first embodiment and first comparative example;

FIG. 16 shows distances from displacement detectors to the surface of the measured cylinder which were obtained in a second embodiment;

FIG. 17 shows differential values which were generated by the rotation in FIG. 7 and were obtained in the second embodiment, and numerical values which were obtained by subtracting the differential values from a constant to be made positive integers;

FIG. 18 shows displacement amounts of the surface of a measured cylinder 1 on the basis of a floating center which were obtained in the second embodiment;

FIG. 19 shows the coordinate value and distances which were obtained in the second embodiment and were obtained by converting FIG. 9 into the rectangular coordinate position;

FIG. 20 shows distances of the above-mentioned respective intersections and respective measuring points on a circumference at each coordinate position, a maximum value, and a minimum value, which were obtained in a third embodiment;

FIG. 21 shows cylindricities of the measured cylinders which were obtained in a fourth embodiment; and

FIG. 22 shows cylindricities of the measured cylinders which were obtained in a fifth embodiment.

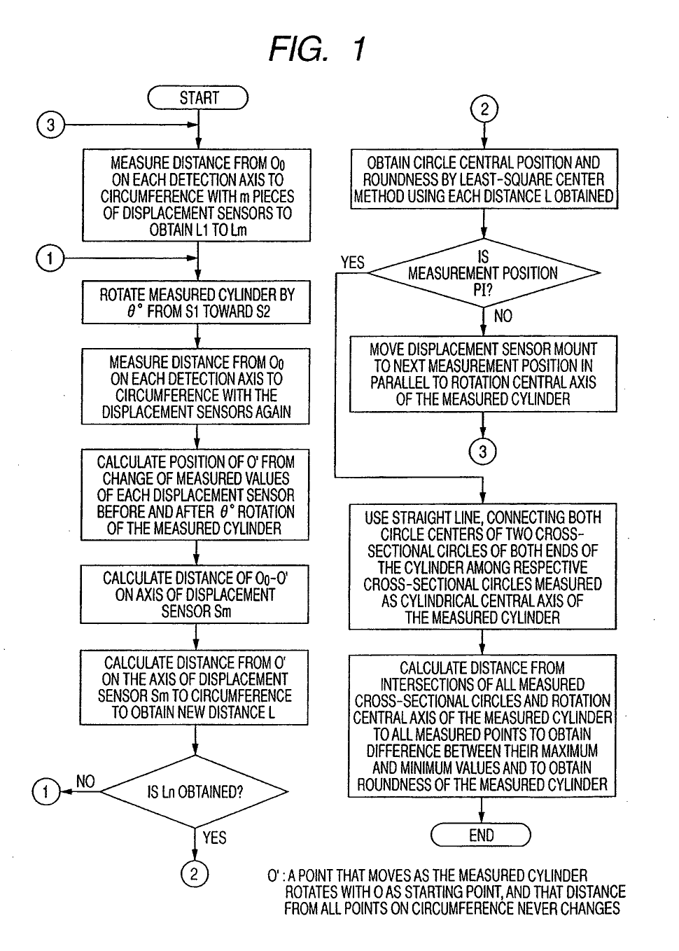

### DESCRIPTION OF THE PREFERRED EMBODIMENTS

The following description is one embodiment of a method used in the present invention, and those skilled in the art should be able to easily understand that the same effect will be obtained also in other forms.

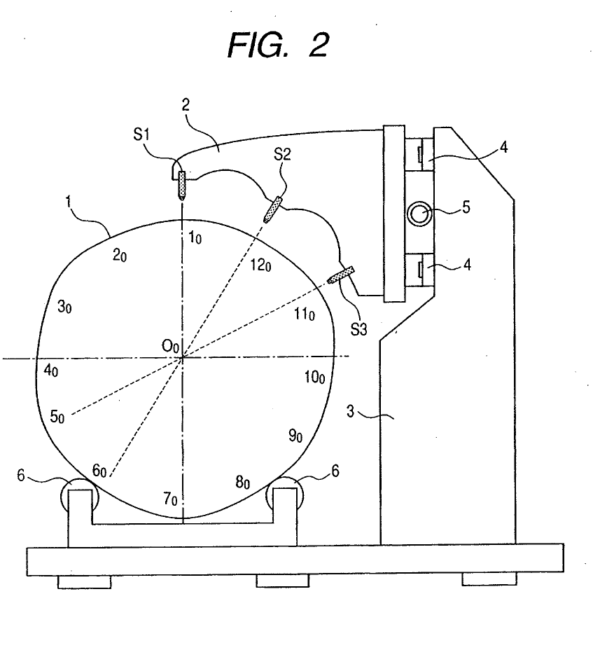

FIG. 2 shows an example of an apparatus used for the shape measurement of a cross-sectional circle of a cylinder which relates to this embodiment. The measuring apparatus concerned receives a measured cylinder 1 on a rotatable cylinder support jig (runners 6), and has three displacement detectors S1, S2 and S3 which are located on the same cross-section, which is orthogonal to a rotation axis of the measured cylinder 1, on a mount 2 mounted reciprocally in parallel to the rotation axis of the measured cylinder 1 by guide rails 4 and a ball screw 5, which are oriented to a measurement reference point O₀ which is an intersection of the rotation axis of the measured cylinder, and the cross-section orthogonal to the rotation axis, and which are arranged in a fan shape every predetermined angle (θ°) with O₀ as a center and are fixed to the mount 2. The three displacement detectors S1, S2 and S3, and rotation centers of two runners 6 are being fixed to the same mechanism, and mutual positions always do not change.

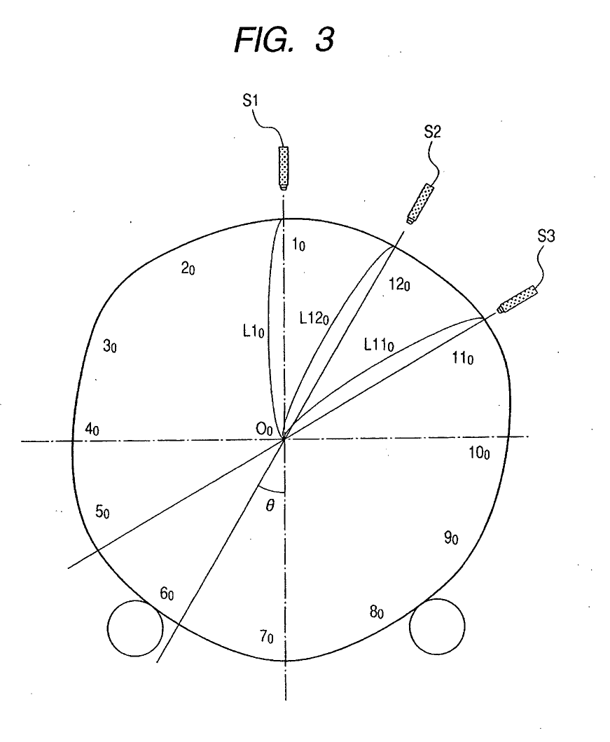

Next, a measuring method of a shape of a cross-sectional circle of the cylinder concerned which is orthogonal to an axis will be described. Here, a rotation angle θ° per one measurement of the measured cylinder 1 was set at 30°. Hence, measuring points on a circumference become 12 points 1₀ to 1₂₀ as shown in FIG. 3. Then, this measuring method finally calculates distance from a starting point (Oₙ₌₀) of a floating center to respective points 1_{0 to 12}₀ on the circumference of a measured circle to specify the shape of the measured circle.

As a first stage, distances L1₀, L12₀ and L11₀ between O₀ (Oₙ₌₀) and the points 1₀, 12₀, and 11₀ on the circumference of the measured circle are measured by using the displacement detectors S1, S2 and S3.

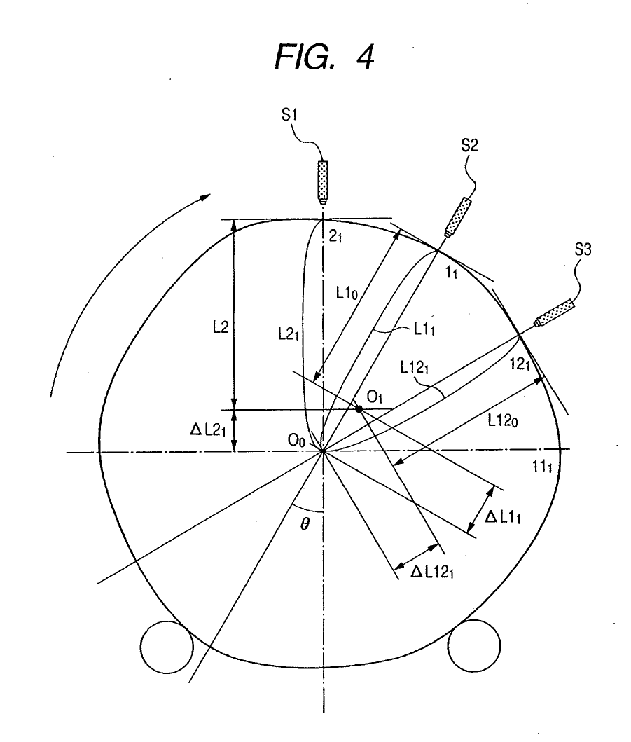

As a second stage, when the cylinder is rotated rightward by 30°, the measuring points 1₀, 12₀, and 11₀ on the circumference in the first stage move to 1₁, 12₁, and 11₁ respectively, and the displacement detectors S1, S2 and S3 become ready-to measure distances between points 2₁, 1₁ and 12₁ on the circumference and the measurement reference point O₀ respectively, as shown in FIG. 4. At this time, assuming that the floating center Oₙ₌₀ does not coincide with a true center of the measured circle, and that the measured circle is not truly round. Oₙ moves to Oₙ₌₁. At this time, the distance between the floating center Oₙ₌₀ and the point 2₁ on the circumference is unknown. Next, the distance L2₁, L1₁ and L12₁ between the points 2₁, 1₁ and 12₁ on the circumference and-the measurement reference point O₀ are respectively measured using the displacement detectors S1, S2 and S3.

Here, a position of a current position Oₙ₌₁ of the floating center Oₙ is obtained from the change of respective distances by rotation. Since L1₀ and L12₀ are known, it is possible to obtain moving distances ΔL1₁ and ΔL12₁ from Oₙ₌₀ to Oₙ₌₁ on each detection axis of the displacement detectors S2 and S3.
ΔL1₁=L1₁−L1₀ (1)
ΔL12₁=L12₁−L12₀ (2)

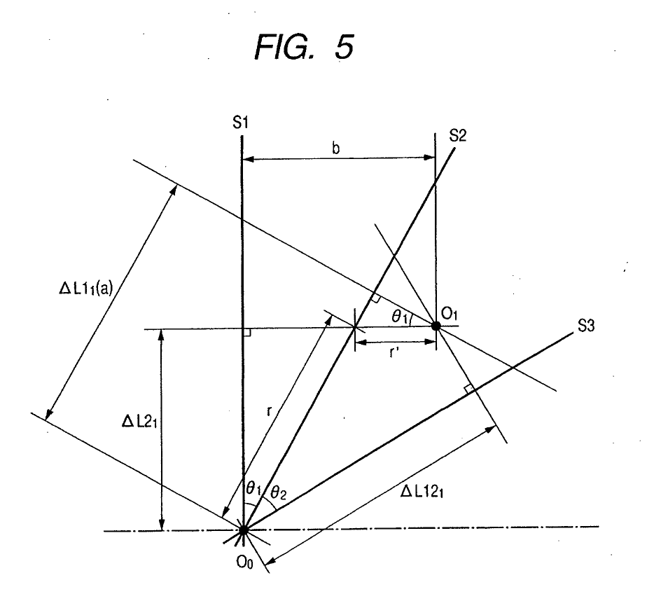

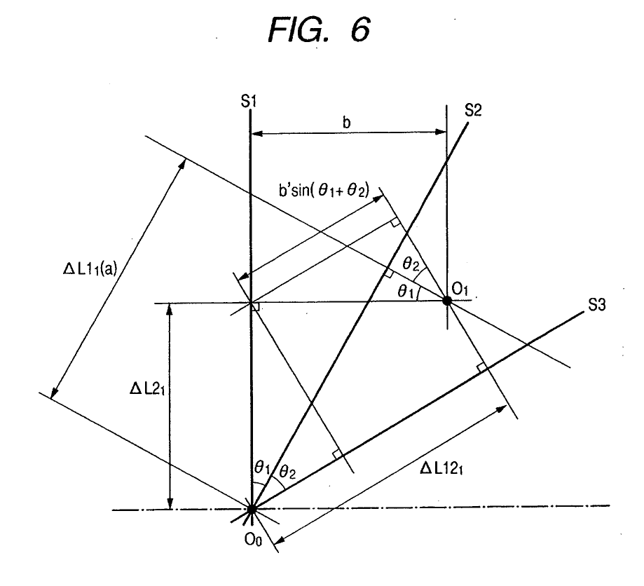

Hereinafter, a moving distance ΔL2₁ of the floating center. Oₙ₌₁ on the detection axis of the displacement detector S1 will be obtained using these two distances. Then, a distance between the floating center Oₙ₌₀ and the point 2₀ on the circumference can be obtained by taking the difference between L2₁ and ΔL2₁. Thus, as shown in FIG. 5, let ΔL₁ be “a”, and let a shortest distance between the detection axis of the displacement detector S1 and the floating center Oₙ₌₁, that is, a moving distance in an x-axial component of the floating center Oₙ₌₁ expressed in orthogonal coordinates where the detection axis of the displacement detector S1 is made a y-axis be “b”. When expressing “a” and “b” using r and r′ shown in FIG. 5, respectively,
r′·sin θ₁+r=a (3)
r′+r·sin θ₁=b (4)
r′=(b−a·sin θ₁)/(cos² θ₁) (5)
r=a−sin θ₁·[(b−a·sin θ₁)/(cos² θ₁)] (6)
Furthermore, from FIG. 5, since being ΔL2₁=r·cos θ₁;
ΔL2₁=a·cos θ₁−tanθ₁(b−a·sin θ₁) (7)
Here, from FIG. 6,
ΔL12₁−b·sin(θ₁+θ₂)=ΔL2₁·cos(θ₁+θ₂) (8)
ΔL2₁=[ΔL12₁−b·sin(θ₁+θ₂)]/[cos(θ₁+θ₂)] (9)
a·cos θ₁−tan θ₁·(b−a·sin θ₁)=[ΔL12₁−b·sin(θ₁+θ₂)]/[cos(θ₁+θ₂)] (10)
b=[a·(cos θ₁+sin θ₁·tan θ₁)·cos(θ₁+θ₂)−ΔL12₁]/[tan θ₁·cos(θ₁+θ₂)−sin(θ₁+θ₂)] (11)

Hence, ΔL2₁ can be obtained with arguments included in the following two formulas, that is, a mutually forming angle and measured values of the displacement detectors.

From the above-mentioned formula 7,
ΔL2₁=ΔL1₁·cos θ₁−tan θ₁·(b−ΔL1₁·sin θ₁) (12)
b=[ΔL1₁·(cos θ₁+sin θ₁·tan θ₁)·cos(θ₁+θ₂)−ΔL12₁]/[tan θ₁·cos(θ₁+θ₂)−sin(θ₁+θ₂)] (13)

From ΔL2₁ obtained using the above-mentioned formulas 12 and 13, L2₀ is obtained as L2₀=L2₁−ΔL2₁.

As a third step, the measured cylinder is rotated further by 30° rightward. Then, the measuring points 2₁, 1₁ and 12₁, on the circumference in the above-mentioned second stage are respectively moved to 2₂, 1₂ and 12₂, and the displacement detectors S1, S2, and S3 become ready to measure distances between the points 3₂, 2₂ and 1₂ on the circumference and the measurement reference point O₀ respectively. In addition, the floating center Oₙ₌₁ further moves to Oₙ₌₂. Next, distances between the points 3₂, 2₂ and 1₂ on the circumference and the measurement reference point O₀ are respectively measured using the displacement detectors S1, S2 and S3. A moving distance from the floating center Oₙ₌₀ to Oₙ₌₂ is calculated by the same method as the above-described method using these measured values. Furthermore, by using the calculation result, a moving distance (ΔL3₂) of Oₙ₌₂ from Oₙ₌₀ on the measurement axis (y-axis) of the displacement detector S1 is obtained and a distance between the floating center Oₙ₌₀ and the point 3₀ on the circumference is obtained from there. Hereinafter, similarly, the cylinder is rotated by 30° at a time for distances L4₀, L5₀, L6₀, L7₀, L8₀, L9₀ and L10₀ between the floating center Oₙ₌₀ and points 4₀, 5₀, 6₀, 7₀, 8₀, 9₀ and 10₀ on the circumference to be obtained, respectively. When calculating L11₀ and L12₀ using the same method at this time, the measurement result with higher accuracy can be obtained.

At this time, as mentioned above, it is not possible to desire the floating center, Oₙ always exists on a detection axis of a displacement measuring instrument since being a point of moving its position as a cylinder rotates. Hence, a shift of the position of the floating center Oₙ to this detection axis generates a measurement error. Nevertheless, let a minimum distance between the floating center Oₙ and the above-mentioned detection axis be ΔL, let a distance between the circumference on the detection axis and the measurement reference position O₀, be L₁, and let a distance between a point, where an axis which is parallel to the detection axis and passes the floating center Oₙ intersects the circumference, and the measurement reference position O₀ be L₂, an error ΔL′ to a detection distance is given as the following formula:
ΔL′=L₁−\sqrt{L₂²−ΔL²}
and hence, ΔL′ is very small. As an example, when a circle whose mean radius is 50 mm, and whose roundness is about 100 μm is made a measuring object, it is supposed that a moving distance of the floating center Oₙ is about 50 μm and ΔL′ is nearly 0.025 μm. This numerical value is 5×10⁻⁵% to a measured value as an error, and is 0.05% to the moving distance of the floating center Oₙ. Hence, when taking into consideration that the measurement reproducibility of a displacement measuring instrument generally regarded as being highly accurate is about 0.1 μm, it can be said that the influence given to the measurement result is extremely small.

In addition, an error which is expected to arise when rotating the measured cylinder 1 according to measurement, and is caused by a rotation angle will be referred to. Let a rotation error angle be θ°, let a distance between the circumference on the detection axis and the measurement reference position O₀ be L₁, and let a distance from the measurement reference position O₀ on an axis which intersects the detection axis with forming the above-mentioned rotation error angle with the measurement reference position O₀ to the circumference be L₂. Then, the error ΔL′ given to the detection distance is given as the following formula:
ΔL′=L₁−L₂·cos θ
and hence, ΔL′ is very small. As an example, when a mean radius of a measuring object circle is 50 mm and 0.1° of rotation error arises, ΔL′ is nearly 0.076 μm. This numerical value is 1.5×10⁻⁴% to a measured value as an error. When taking into consideration that it is possible to expect that the reproducibility of stopping accuracy of a general and low-price rotating mechanism is about 0.04° sufficiently in addition to the measurement reproducibility of the above-mentioned ordinary displacement measuring instrument, it can be said that the influence of this error given to the measurement result is extremely small.

Then, a circle central position and each radial distance in a position in rectangular coordinate position are calculated from the obtained distances L1₀ to L12₀ using the known least-square circle center method.

Next, let the floating center Oₙ₌₀ be an origin (0, 0) in orthogonal coordinates, and positions of measuring points 1₀ to 12₀ on the circumference in the orthogonal coordinates will be obtained from distances L1₀ to L12₀. For the convenience of calculation, i is once substituted for r to be made an argument of the measuring points 1₀ to 12₀, and let components of the rectangular coordinate position be xᵢ and yᵢ. They can be obtained by the following formulas:
xᵢ=L₁·sin{−θ₁·(i−1)}
yᵢ=L₁·cos{−θ₁·(i−1)}
In addition, a reason why θ₁ is used as a negative angle in the above formula is because of expressing a position of each measuring point in the orthogonal coordinates in conformance to FIG. 3. Let the Y-axis of the rectangular coordinate system be 0°, and the angle is added sequentially counterclockwise.

Here, let a position of the true circle center O in the orthogonal coordinates be O (x, y), and it is possible to obtain them from the following formulas:

$$x = \frac{2 Σ {x}_{i}}{12} y = \frac{2 Σ {y}_{i}}{12}$$

At this time, a number 12 given to denominators of both of left and right items is a number obtained by dividing 360° by θ₁, that is, 30°, and this number changes with θ₁.

Then, a roundness A will be obtained. With substituting the obtained O (x, y) for the origin (0, 0), let positions of the measuring points, 1₀ to 12₀ on the circumference, which move with this, be 1₀′ to 12₀′. Then, components (xₙ, yₙ) of rectangular coordinate position are given from the following formulas:
Xₙ=Xᵢ−x, Yₙ=Yᵢ−Y
True radial displacement amounts L1₀′ to L12₀′are given from components (xₙ, yₙ) of the rectangular coordinate positions 1₀′ to 12₀′ which are obtained, with the following formulas:
Lₙ′\sqrt{xₙ²+yₙ²}
At this time, it is possible to obtain the roundness A of a cross-sectional circle orthogonal to a central axis as the difference between maximum and minimum values of L1₀′ to L12₀′.

The above measurement and calculation is performed for a desired cross-sectional circle, which is orthogonal to each central axis of the measured cylinder 1, and a circle center position and a radial displacement amount of each measured cross-sectional circle are obtained.

Next, a cylindricity of the measured cylinder 1 will be obtained.

A position of each intersection of a straight line connecting both circle centers of two cross-sectional circles, which are orthogonal to a central axis and are both ends of the measured cylinder 1, among the cross-sectional circles which are orthogonal to each measured central axis and are measured, and other cross-sectional circles orthogonal to respective central axes will be obtained by distance proportion. Then, a displacement amount on a straight line connecting each intersection, mentioned above, and each measuring point on a circumference is calculated as a radial distance using the method shown in formula 13. Here, it is possible to obtain the difference between maximum and minimum values of all the obtained distances as a cylindricity of the measured cylinder.

Since the measuring method described above is small in degrees of functions being influenced according to an outer diameter, an internal diameter, and a length of a measured cylinder, for example, in an outer diameter, it is possible to use this from a very thin object of about 5 mm to a thick object of several meters. Furthermore, there are many displacement detection means which can be used for this measuring method, and it is effective to use means of, for example, an electric micrometer, an eddy current type displacement detector, a laser displacement detector,sa dial gauge, or the like. In addition, when there is a possibility of affecting measurement result because of generating elastic deformation such as bending in response to the influence of gravity during measurement because of the measured cylinder being too much thin to own length and weight, soft as a material, very thin, or the like, it is effective to perform measure by bringing the cylinder central axis of the measured cylinder closely to and in parallel to gravity or another external active direction.

In addition, in order to increase further the accuracy of a cylindricity to be finally obtained, it is preferable that a position of a cross-section orthogonal to a central axis of both ends is closer to the both end sections of a measured cylinder.

Here, when performing measurement by a plurality of rotations with changing a position in a cylinder axial direction like the above-mentioned measurement of a cylindricity, the accuracy of means of moving a displacement detector in parallel to a direction of a cylinder axis like the above-mentioned guide rails 4 generally becomes important. Nevertheless, a shape of a locus of the above-mentioned floating center obtained when a measured cylinder rotates at the time of measurement is nearly a circle. In addition, when a measured cylinder is placed on runner-like cylinder support jig like the above and rotates, the same rotation will be repeated, if the rotational vibration of the runner-like cylinder support jig is very small. Thus, even if a measured cylinder rotates two or more times, ail the points of a cylindrical surface follow the always almost same locus every rotation. From this, even if a plurality of loci of the above-mentioned floating center are obtained when measurement is performed by a plurality of rotations with a position in a direction of a cylinder axis being changed like the measurement of a cylindricity, all the loci, that is, circular shapes have almost concentric relation, or even if they are not circular, they have similar shapes which shares a center position. Hence, when arranging a plurality of cross-sectional circles, obtained by measurement, with the above-mentioned center position as a common basis, it becomes possible to calculate and measure a cylindricity which is not affected by the accuracy of moving means of a displacement detector like the above-mentioned guide rails 4.

Furthermore, it is also effective in shortening of measuring time to perform measurement by a displacement detector without stopping rotation in each measurement position when rotating a measured cylinder in measurement of a circumferential shape of a cross-sectional circle orthogonal to each cylinder central axis.

Moreover, it is also very effective to perform measurement only in smaller times of rotations, and in particular, one rotation by measuring circumferential shapes of a plurality of cross-sectional circles orthogonal to the cylinder central axis simultaneously-using a plurality of above-mentioned mounts which fix each displacement detector.

Although the present invention will be explained below specifically using examples, the present invention is not limited by such examples.

### EXAMPLE 1

Ten A3003 aluminum pipes which had been given machining beforehand as a measured cylinder, and which had a machining set outer diameter of 84.0 mm, an inner diameter of 78.0 mm, and a length of 360.0 mm were prepared, and were named Sample No. 1 to Sample No. 10.

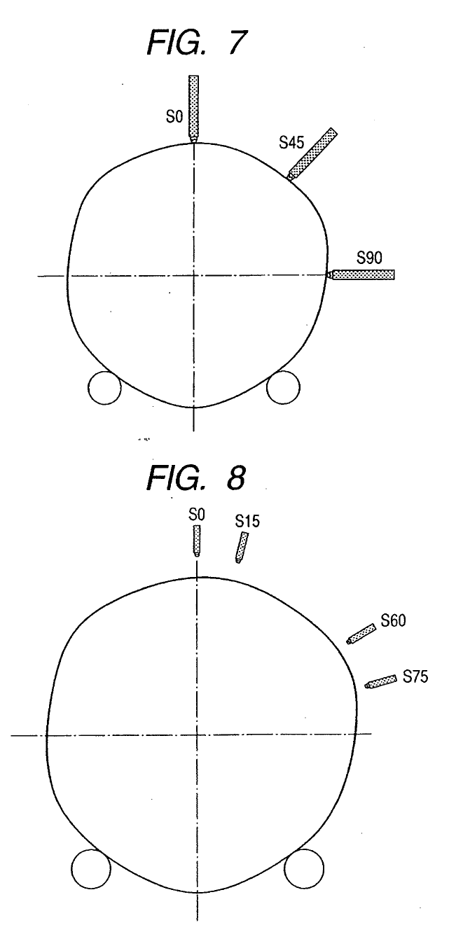

The measured cylinder Sample No. 1 was placed on a cylinder support jig of a cylinder measuring instrument where, as shown in FIG. 7, three displacement detectors S0, S45 and S90 were arranged in a fan-like shape with measurement axes of respective displacement detectors intersecting with each other at a predetermined point within a cross-sectional circle orthogonal to an axis of the cylinder, and with partner sensors forming an angle of 45° with the point as a center. The above-mentioned three displacement detectors were arranged apart 80 mm from an end of the measured cylinder in a central axis direction of the cylinder, and each displacement detector was an MCH335 electric micrometer made by Mitsutoyo Co., Ltd. Then, measurement was performed totally 8 times with the above-mentioned rotation drive transfer machine by rotating the cylinder by 45° every measurement. In addition, a distance from the intersection of the above-mentioned detection axes to each displacement detector had been measured beforehand, and a measured value of the displacement detector in this embodiment is shown as what measured a distance from the intersection of respective detection axes to an intersection of a cylindrical surface on the same cross-section orthogonal to a rotation axis of the measured cylinder and each of the above-mentioned detection axes.

The measured cylinder was rotated at 6 revolutions per minute when measuring. Measurement was performed with defining that the time which the measurement took at this time was the time required from placing the measured cylinder on the above-mentioned cylinder support jig to completing one rotation of the measured cylinder for measurement.

Hereinafter, in tables in drawings used in the first example, measurement in S0 position at the time of measurement start is set to 0°, and 45° is added by turns to a position on the circumferential surface which arrives S0 according to a rotation of the measured cylinder.

In order to obtain a moving distance of the above-mentioned floating center, each moving distance on the detection axes of the displacement detectors S45 and S90 is calculated using the above-mentioned formulas 1 and 2. At this time, a moving distance on each axis is calculated as difference between a measured value of S45 and a measured value of S0 before 45° of rotation on the detection axis of S45, and difference between a measured value of S90 and a measured value of S45 before 45° of rotation on the detection axis of S90, respectively.

Next, using the above-mentioned formula 13, Δx in a rectangular coordinate position was obtained, and Δy was calculated next, using the above-mentioned formula 12. Here, Δx and Δy are moving distances of the floating center Oₙ shown in a rectangular coordinate position. Then, a true value of an S0 position, that is, a distance to a measured cylinder surface on the basis of the floating center Oₙ was calculated by subtracting this Δy from the measured value of S0.

Next, a distance to each point on the basis of the floating center Oₙ was converted into a rectangular coordinate position. Using Xₙ and Yₙ obtained in this way, a true circle center coordinates O (x, y) were obtained by the above-mentioned least-square circle center method, and a center X coordinate and a center Y coordinate were obtained.

Then, distances of the X axial component and Y axial component from the obtained center coordinate position to each point, a direct distance to each point, that is, a radial distance of each true point, and further, a roundness was obtained from the difference of a maximum value and a minimum value of them.

About the above, Sample No. 2 to Sample No. 10 were measured similarly, and the above-mentioned durations and roundnesses were obtained.

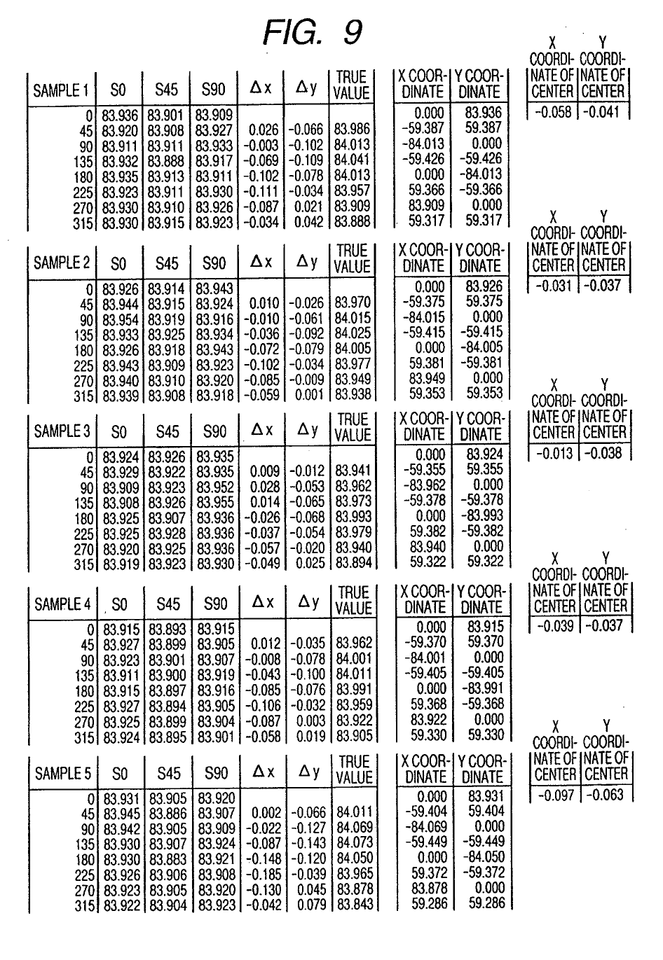

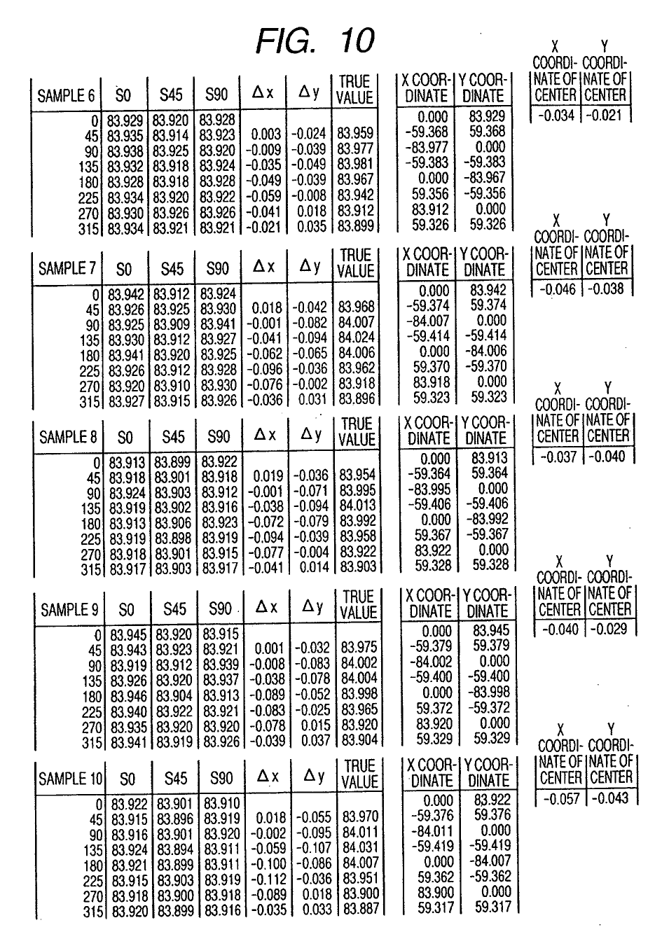

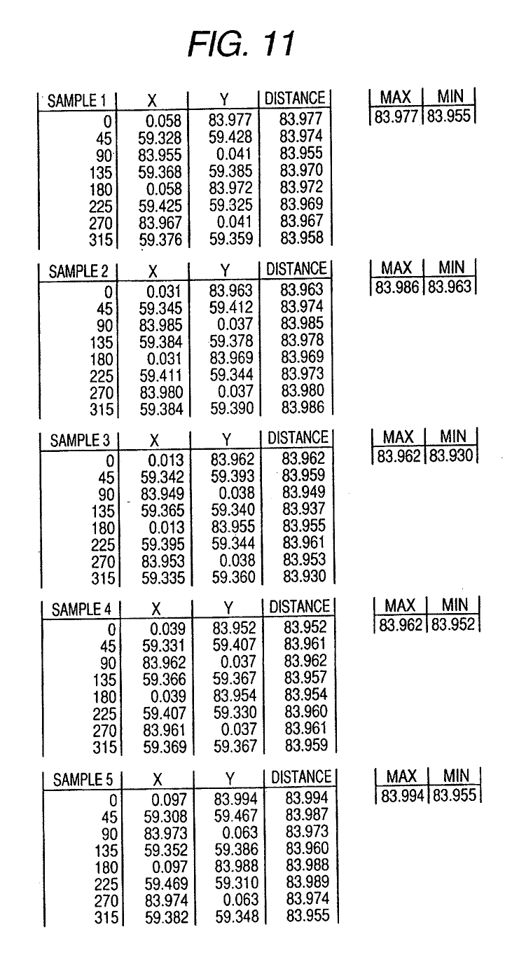

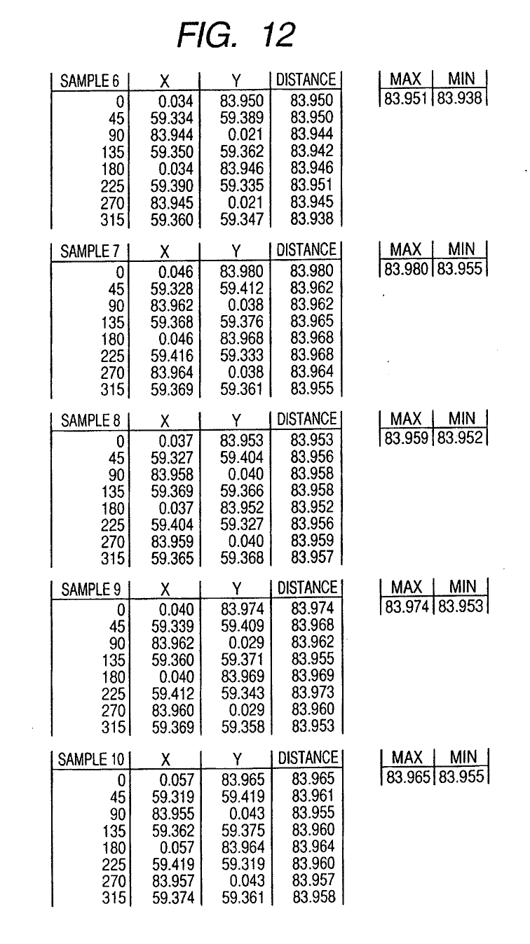

FIGS. 9 and 10 show data from measured values of each of the above-mentioned displacement detectors to the above-mentioned circle center coordinate positions among data obtained by the above measurement. Then, FIGS. 11 and 12 show distances of the X axial component and Y axial component from the above-mentioned center coordinate position to each point, distances to each point, and maximum and minimum values of them.

### COMPARATIVE EXAMPLE 1

Each outer surface roundness at a position apart 80 mm from the lower edge at the time of placement of the measured cylinder in a direction of the cylinder central axis was measured for the aluminum pipes Sample No. 1 to Sample No. 10 measured in the first example using a roundness measuring instrument (trade name: round test RA-H5000AH, made by Mitsutoyo Co., Ltd.). Each duration for measurement was measured as the time required from placing the measured cylinder on a rotary table to completing a series of programs which continuously ran for automatic centering, automatic leveling, and automatic measurement.

In addition, as for the above-mentioned automatic centering and an automatic leveling steps, an automatic and high-speed mode was adopted, a centering position was set at 20 mm from a lower edge of the measured cylinder, a leveling position was set at 80 mm from the above-mentioned lower edge, a magnification was set at 5000×, an area was set at 8 μm, and the rotating speed of the rotary table was set at 10 rpm. Then, the automatic centering, automatic leveling, and roundness measurement were implemented. In addition, when placing the measured cylinder on the above-mentioned rotary table, the measured cylinder was directly placed without using a three-claw chuck, made by the company, and other fixtures in consideration of shortening of the measurement time. In addition, in order to delete the increase of the above-mentioned duration arising from a plurality of operation of the automatic centering and automatic leveling, data of measurement which required two or more times of automatic centering or automatic leveling was not adopted as data, measurement was retried until the measurement which required only one operation of automatic centering or automatic leveling was achieved, and this data was adopted as the data of the duration.

(Evaluation)

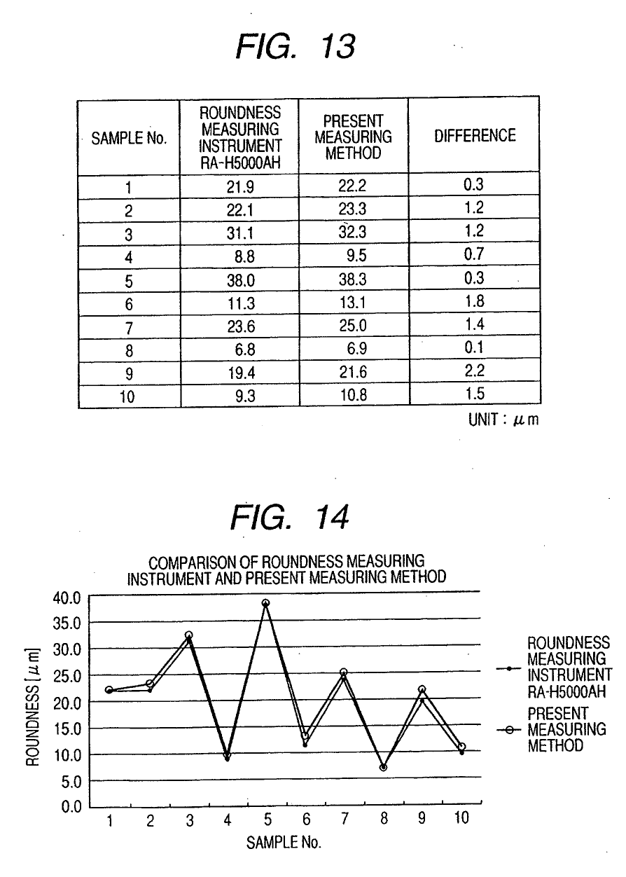

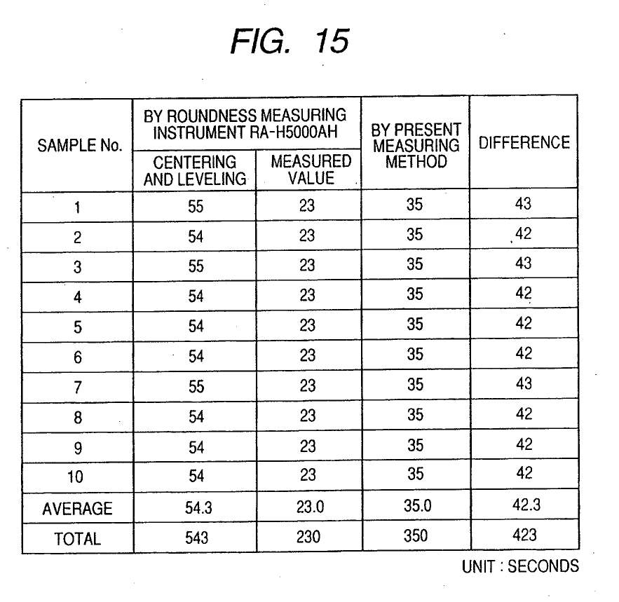

FIGS. 13 and 14 show a value of each roundness and each difference measured in the first example and first comparative example. In addition, FIG. 15 shows each duration measured in the first example and first comparative example.

From FIGS. 13 and 14, the difference between the measurement results by respective measuring methods, that is, the first example and first comparative example is 2.2 nm at the maximum, and hence, it can be judged that it is sufficiently small.

In addition, from FIG. 15, it is possible to confirm that a measurement duration of the first example is shortened by 54.7% to a measurement duration of the first comparative example.

### EXAMPLE 2

An A3003 aluminum pipe which had been given machining beforehand as a measured cylinder, and which had a machining set outer diameter of 80.0 mm, an inner diameter of 74.0 mm, and a length of 360.0 mm was prepared.

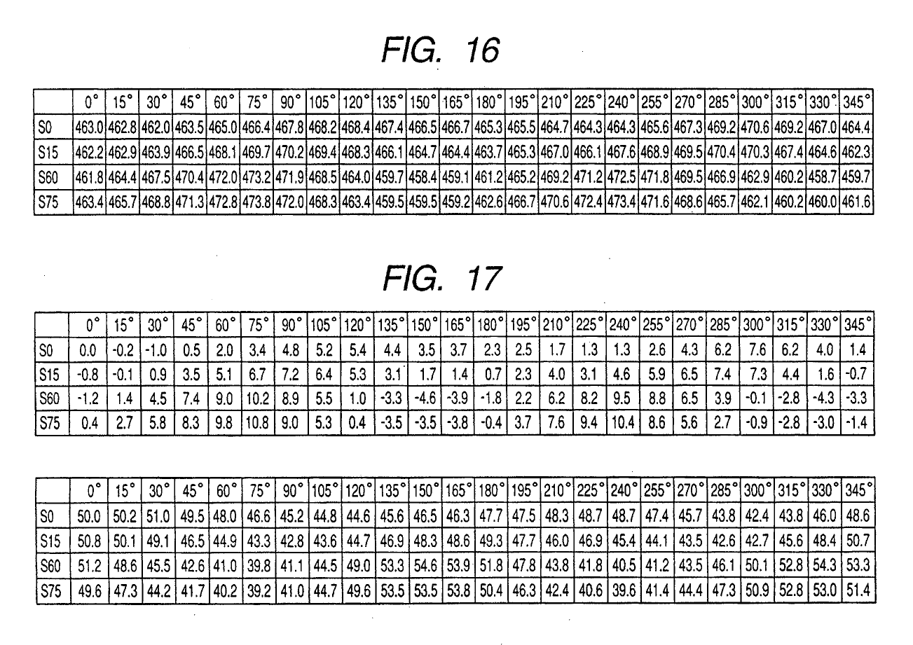

This measured cylinder was placed on the cylinder support jig of the same cylinder measuring instrument as that in FIG. 2. Displacement detectors S0, S15, and S60 and S75 were arranged on a mount, which is shown in FIG. 8, so that the displacement detectors might be located on the same cross-section, which was orthogonal to a rotation axis and was apart 30 mm from an end of the measured cylinder in a direction of a cylinder central axis, and might be oriented to an intersect of the rotation center of the measured cylinder and the cross-section orthogonal to the rotation axis, with the above-mentioned intersection as a center, and with forming an angle of 15° with another partner, respectively. Furthermore, S0 and S60 were arranged so that they might form an angle of 60°. As each displacement detector, an eddy current type displacement-detector made by KAMAN Corp. was used, and a position of each displacement detector was adjusted so that each distance from the above-mentioned intersection might become equal. Then, measurement was performed totally 24 times with the above-mentioned rotation drive transfer machine by rotating the cylinder by 15° every measurement. A displacement amount between each displacement detector and a surface of the measured cylinder was measured as a distance. Hereinafter, in tables in drawings used in the second and third examples, measurement in an S0 position at the time of measurement start is set to 0°, and 15° is added by turns to a position on the circumferential surface which arrives S0 according to a rotation of the measured cylinder. This is shown in FIG. 16.

Next, in order to regard each measured value as differential value for convenience of calculation, let a first measured value, that is, a measured value of the displacement detector S0 at the time of the measured cylinder not rotating once be 0, and all the other measurement results were calculated as differentials between with S0. In addition, in order to perform subsequent calculation smoothly, all the differential values were converted into positive numbers. In this example, all the differential values were subtracted from 50 μm which was an arbitrary constant to be made positive numerical values. This is shown in FIG. 17.

Next, in order to obtain a moving distance of the above-mentioned floating center, each moving distance on the detection axes of the displacement detectors S15 and S75 is calculated using the above-mentioned formula 2. At this time, the moving distance on each axis is calculated as difference between a measured value of S15 and a measured-value of S0 before 15° of rotation on the detection axis of S15 and difference between a measured value of S75 and a measured value of S60 before 15° of rotation on the detection axis of S75, respectively.

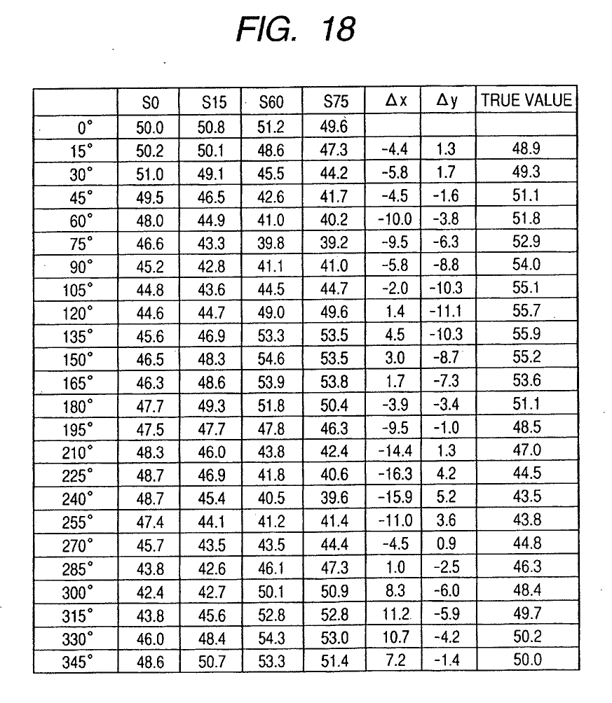

Δx in a rectangular coordinate position was obtained from the obtained moving distances on the two axes using a term b among the formulas shown in the above-mentioned formula 12, and Δy was calculated next, using a term of Δ2₁ shown in the above-mentioned formula 12. Then, a true value of an S0 position, that is, a displacement amount of a surface of the measured cylinder 1 on the basis of the floating center Oₙ was obtained by subtracting this Δy from the measured value of S0. Hereinafter, residual measurements of the measured cylinder to one-round measurement were performed similarly. This is shown in FIG. 18.

Next, the true center of a circle will be obtained.

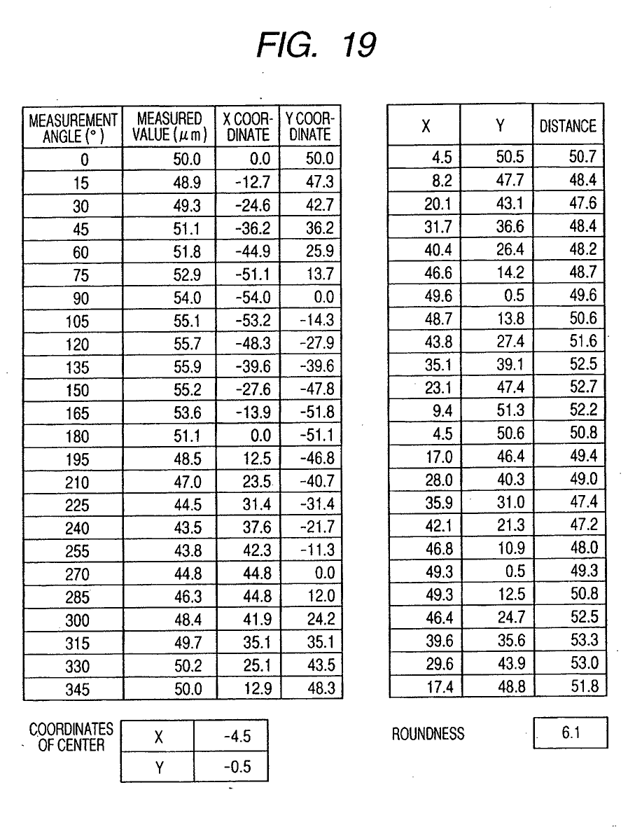

The displacement amounts of respective points on the basis of the floating center Oₙ which had been obtained in FIG. 18 were converted into rectangular coordinate components. Then, using Xₙ and Yₙ obtained in this way, a true circle center coordinates O (x, y) were obtained by the above-mentioned least square circle center method, and (−4.5, −0.5) was obtained. In addition, 6.1 μm was obtained as the roundness by obtaining the displacement amounts of X axial component and Y axial component in each point on the basis of the floating center Oₙ, the true displacement amount in the radial direction to each point, and the difference between a maximum value (53.3 μm) and a minimum value (47.2 μm) of them. This is shown in FIG. 19.

### EXAMPLE 3

Let 20 cross-sectional circles, which were apart 30 mm, 35 mm, 40 mm, 60 mm, 80 mm, 90 mm, 120 mm, 140 mm, 150 mm, 180 mm, 200 mm, 210 mm, 240 mm, 260 mm, 270 mm, 300 mm, 310 mm, 320 mm, 330 mm, and 350 mm from one end of the measured cylinder 1 toward another end and were orthogonal to a cylinder central axis, be measured circles. Then, using the instrument described in the second example, measurements at 24 points totally every 15° per one-round measurement were performed to these, respectively, and the distance between each displacement detector and the surface of the measured cylinder was obtained.

Next, after the measured values being made positive differential values using the same method as that in the second example, displacement amounts of a surface of a measured cylinder on the basis of the floating center Oₙ of each measured circle were obtained similarly to the second example.

Next, similarly to the second example, X and Y axial components of a displacement amount of each point on the basis of the center coordinates of each measured circle, that is, the floating center Oₙ, a maximum value and a minimum value of each circle, and a roundness by these were obtained.

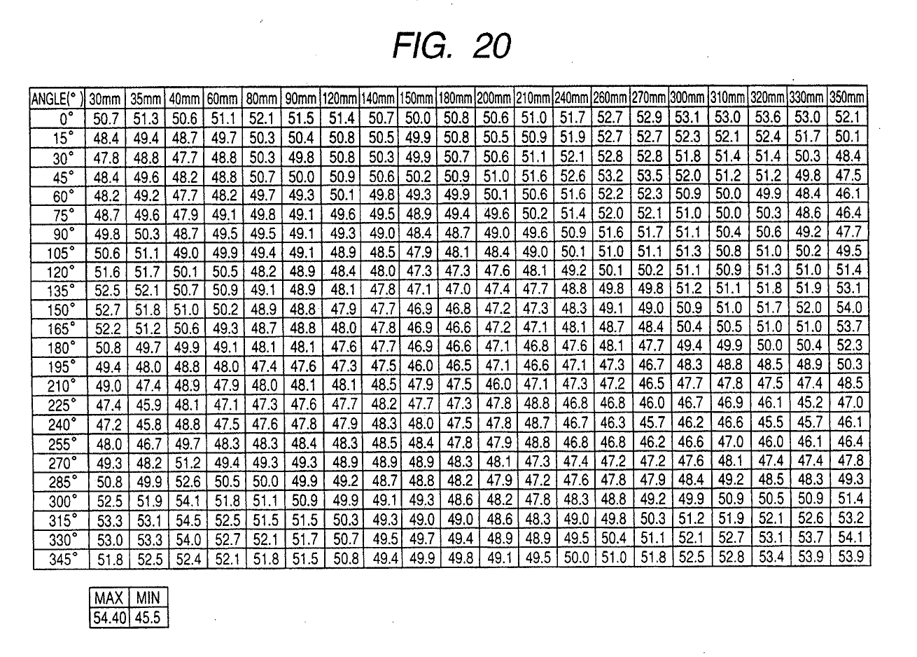

Then, what were obtained were positions of intersections of a straight line connecting both circle centers of two measured circles, located in both ends among the 20 measured circles which were measured, that is, the circle at the 30 mm position in the direction of the cylinder central axis and the circle at the 350 mm position, and other measured circles by the distance proportion. Next, a displacement amount as x and y coordinate components of each measuring point on the circumference on the basis of the above-mentioned each intersection was calculated every measured circle. Furthermore, a radial displacement amount of each measuring point on the circumference on the basis of the above-mentioned each intersection was calculated from the displacement amount as the above-mentioned each coordinate component. This is shown in FIG. 20. Here, 9.0 μm of cylindricity of the measured cylinder was obtained with the difference of a maximum value (54.5 μm) and a minimum value (45.5 μm) of all the obtained distances.

### EXAMPLE 4

Ten A3003 aluminum pipes which had been given machining beforehand as measured cylinders, and which had a machining set outer diameter of 30.0 mm, an inner diameter of 28.5 mm, and a length of 260.0 mm were prepared.

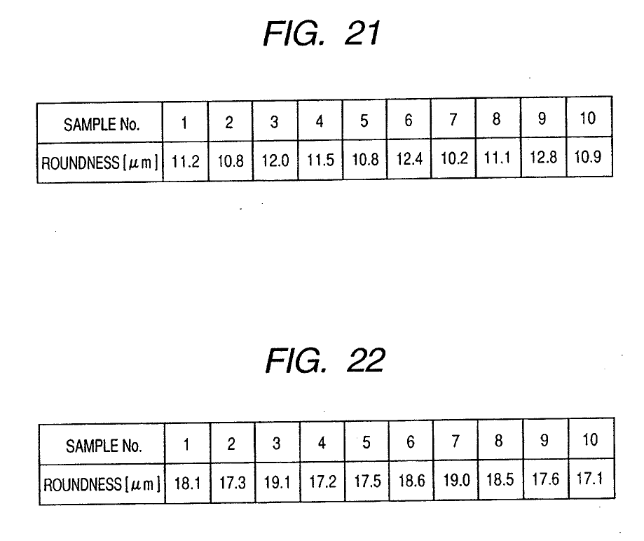

This measured cylinder was placed on the cylinder support jig of the same cylinder measuring instrument as that in FIG. 2. Let 12 cross-sectional circles, which were apart 30 mm, 40 mm, 60 mm, 80 mm, 90 mm, 120 mm, 140 mm, 150 mm, 180 mm, 200 mm, 210 mm, and 240 mm from one end of the measured cylinder 1 toward another end and were orthogonal to a cylinder central axis, be measured circles. A cylindricity was measured by the same method as that in the third example to these, respectively. This result is shown in FIG. 21.

### EXAMPLE 5

Ten A3003 aluminum pipes which had been given machining beforehand as measured cylinders, and which had a machining set outer diameter of 180.0 mm, an inner diameter of 174.0 mm, and a length of 370.0 mm were prepared.

This measured cylinder was placed on the cylinder support jig of the same cylinder measuring instrument as that in FIG. 2. Let 20 cross-sectional circles, which were apart 30 mm, 35 mm, 40 mm, 60 mm, 80 mm, 90 mm, 120 mm, 140 mm, 150 mm, 180 mm, 200 mm, 210 mm, 240 mm, 260 mm, 270 mm, 300 mm, 310 mm, 320 mm, 330 mm, and 350 mm from one end of the measured cylinder 1 toward another end and were orthogonal to a cylinder central axis, be measured circles. A cylindricity was measured by the same method as that in the third example to these, respectively. This result is shown in FIG. 22.

Since the present invention makes cylindrical measurement easy, its utilization is expected as technology for producing an accurate cylindrical member.

This application claims priority from Japanese Patent Application No. 2004-254363 filed on Sep. 1, 2004, which is hereby incorporated by reference herein.

What is claimed is:

1. A measuring method of a shape of a cross-sectional circle which is orthogonal to an axis of a cylinder, comprising a step of calculating distances between a reference point and points on a circumference on the basis of change of the distances of at least three predetermined points on the circumference of the cross-sectional circle to the reference point set in the cross-sectional circle by rotation of the cylinder, and specifying the shape of the cross-sectional circle.

2. A measuring method of a cylindrical shape of a cylinder, comprising a step of measuring shapes of a plurality of cross-sectional circles which are orthogonal to an axis of the cylinder, wherein measurement of the shapes of the cross-sectional circles is performed using the measuring method according to claim 1.

3. A measuring method of a cylindrical shape which obtains a cylindricity of a measured cylinder by the following steps (i) to (vi) using measuring means having a cylinder support jig on which the measured cylinder is placed and which rotates this, and three or more displacement detectors which are located on the same cross-section, which is orthogonal to a rotation axis of the measured cylinder, on a mount provided rotatably in parallel to the rotation axis of the measured cylinder, which are oriented to the measurement reference point (O₀) which is an intersection of the rotation axis of the measured cylinder, and the cross-section orthogonal to the rotation axis, and which are arranged in a fan shape every predetermined angle (θ°) with O₀ as a center and are fixed to the mount, comprising:
(i) a step of measuring a distance from a measurement reference point to points on the circumference of the cross-sectional circle orthogonal to the axis of the measured cylinder by displacement detectors,
(ii) a step of repeating the step (i) in a state of rotating the measured cylinder by O₀,
(iii) a step of calculating respective distances from the measurement reference point to n points (n=360/θ) on the circumference of the cross-sectional circle by repeating the steps (i) and (ii),
(iv) a step of calculating a circle center position and a roundness of the cross-sectional circle by a least-square circle center method using these respective distances,
(v) a step of moving the mount in parallel to a rotation central axis of the measured cylinder and calculating a circle center position and a roundness of each cross-sectional circle by the steps (i) to
(iv) about different-cross-sectional circles of the measured cylinder, and
(vi) a step of making a straight line, which connects the circle centers of two cross-sectional circles in both ends of the measured cylinder among the cross-sectional circles from which the circle center positions and roundness are calculated at the steps (i) to (v); be a cylinder central axis, calculating distances from each intersection point of this circle central axis and the cross-sectional circles other than the two cross-sectional circles in the ends of the measured cylinder among the cross-sectional circles, from which these circle center positions and roundness are calculated, to the predetermined points on the circumference of each cross-sectional circle, and obtaining the difference between a maximum value and a minimum value of the distance.

4. The measuring method of a cylindrical shape of a cylinder according to claim 2, comprising two displacement detectors A and B arranged with sandwiching an angle θ, and two displacement detectors A′ and B′ arranged with sandwiching an angle θ, wherein an angle formed by A and A′, or B and B′ is positive integer-times of θ.

5. The measuring method of a cylindrical shape. of a cylinder according to claim 2, wherein a displacement detector is arranged in the measured cylinder to obtain a wall thickness, a circle center of an inner circumferential circle, and a roundness of the measured cylinder.

6. A measuring method of a cylindrical shape of a composite cylinder, comprising the steps of measuring at least one cylinder, which constitutes the composite cylinder, by method of claim 2 for the composite cylinder which is constituted of a plurality of cylinders whose diameters are different, and shares a rotation central axis in outer circumferential circles of all the cylinders, measuring cylindrical shapes of cylinders other than the one cylinder using at least one displacement detector respectively, and obtaining all cylindrical shapes, a concentricity, and wall thicknesses of the composite cylinder.

7. A measuring apparatus of a cylindrical,shape, comprising measuring means having a cylinder support jig on which the measured cylinder is placed and which rotates this, three or more displacement detectors which are located on the same cross-section, which is orthogonal to a rotation axis of the measured cylinder, on a mount provided rotatably in parallel to the rotation axis of the measured cylinder, which are oriented to the measurement reference point (Oₙ) which is an intersection of the rotation axis of the measured cylinder, and the cross-section orthogonal to the rotation axis, and which are arranged in a fan shape every predetermined angle (θ°) with O₀ as a center and are fixed to the mount, and calculation means of executing the following steps (i) to (vii):
(i) a step of measuring distance from a measurement reference point to points on the circumference of the cross-sectional circle orthogonal to the axis of the measured cylinder by displacement detectors,
(ii) a step of repeating the step (i) in a state of rotating the measured cylinder by θ,
(iii) a step of calculating respective distance from the measurement reference point to n points (n=360/θ) on the circumference of the cross-sectional circle by repeating the steps (i) and (ii),
(iv) a step of calculating a circle center position and a roundness of the cross-sectional circle by a least square circle center method using these respective distance,
(v) a step of moving the mount in parallel to a rotation central axis of the measured cylinder and calculating a circle center position and a roundness of each cross-sectional circle by the steps (i) to (iv) about different cross-sectional circles of the measured cylinder, and
(vi) a step of making a straight line, which connects the circle centers of two cross-sectional circles in both ends of the measured cylinder among the cross-sectional circles from which the circle center positions and roundness are calculated at the steps (i) to (v), be a cylinder central axis, calculating distances from each intersection of this circle central axis and the cross-sectional circles other than the two cross-sectional circles in the ends of the measured cylinder among the cross-sectional circles, from which these circle center positions and roundness are calculated, to the predetermined points on the circumference of each cross-sectional circle, and obtaining the difference between a maximum value and a minimum value of the distances.
